(19) United States
(12) Patent Application Publication
(10) Pub. No.: US 2023/0366665 A1
(43) Pub. Date: Nov. 16, 2023

(54) Scaling Rulers

(71) Applicant: Eric Clifton Roberts, Tyler, TX (US)

(72) Inventor: Eric Clifton Roberts, Tyler, TX (US)

(21) Appl. No.: 17/744,696

(22) Filed: May 15, 2022

(51) Int. Cl. G01B 3/04; G01B 3/00

(52) U.S. Cl. CPC G01B 3/04; G01B 3/004

(57) ABSTRACT

Scaling rulers for generating and displaying custom scaled units in accordance with embodiments of the invention are disclosed. In one embodiment, a scaling ruler is provided, comprising: a pointer configured to move along the scaling ruler, a ruler display configured to display scaled units, a control module comprising a processor operatively connected to the pointer and the ruler display, and memory storing a program comprising instructions that, when executed by the processor, cause the scaling ruler to: receive a pointer input from a user, receive a measurement input from the user, calculate a scaling factor based on the pointer input and the measurement input, and generate scaled units based on the scaling factor and display the scaled units on the ruler display.

### FIELD OF THE INVENTION

The present disclosure generally relates to rulers and more specifically to scaling rulers for generating and displaying scaled units.

### BACKGROUND

A ruler is a device that may be used for geometry and technical drawings. For example, a ruler may be used in various engineering and construction settings to measure distances or draw straight lines. Typically, rulers have permanent length markings in one or more units (e.g., inches or centimeters) along their top and/or bottom edges. Length may be described as a measure or quantity of distance and may be represented using a selected unit.

### SUMMARY OF THE INVENTION

The various embodiments of the present scaling rulers for generating and displaying scaled units have several features, no single one of which is solely responsible for their desirable attributes. Without limiting the scope of the present embodiments as expressed by the claims that follow, their more prominent features now will be discussed briefly. After considering this discussion, and particularly after reading the section entitled “Detailed Description,” one will understand how the features of the present embodiments provide the advantages described herein.

One aspect of the present embodiments includes the realization that drawings such as, but not limited to, engineering and architectural drawings (e.g., CAD drawings) often come scaled. Conventional scaling may be based on sheet sizes such that once the drawing is printed (hardcopy or to another digital format), the printed drawings are some scaled version of the original (e.g., 1/16″ scale, etc.). In conventional scaling techniques, problems may arise such as, but not limited to, a variety of print options, not knowing the original CAD drawing sizes, software translating a CAD to other file types, etc. that may alter the CAD drawing's scale. This leads to countless drawings using the common phrase, “NOT TO SCALE,” “DO NOT SCALE FROM DRAWING,” and other similar phrases. This is a frustration of many users of drawings that may need to estimate materials, costs, sizes, etc. to appropriately plan and use the drawings and information within the drawings and inferred from the drawings. In many situations, not all desired dimensions may be anticipated. These frustrations and challenges may be seen in physical documents (e.g., hardcopy documents), digital documents, CAD and various other drawing/file types, and any other reproduced item (drawing or physical embodiment) that are not of an original scale. The present embodiments solve these problems by quickly and easily translating various scales, as further described below.

In a first aspect, scaling ruler is provided, comprising: a pointer configured to move along the scaling ruler; a ruler display configured to display scaled units; a control module comprising a processor operatively connected to the pointer and the ruler display; and memory storing a program comprising instructions that, when executed by the processor, cause the scaling ruler to: receive a pointer input from a user; receive a measurement input from the user; calculate a scaling factor based on the pointer input and the measurement input; and generate scaled units based on the scaling factor and display the scaled units on the ruler display.

In an embodiment of the first aspect, the scaling ruler further comprises a base, wherein the pointer moves along the scaling ruler via the base.

In another embodiment of the first aspect, the scaling ruler includes a first edge and a second edge.

In another embodiment of the first aspect, the scaling ruler receives the pointer input from the user when the user moves the pointer into a position indicating a known dimension.

In another embodiment of the first aspect, the pointer input is a distance between the first edge and the position of the pointer.

In another embodiment of the first aspect, the scaling factor is calculated by assigning a value to the pointer input and dividing the measurement input by the value assigned to the pointer input.

In another embodiment of the first aspect, wherein a space between the first edge and the second edge is assigned positional values.

In another embodiment of the first aspect, the scaled units are generated by multiplying the positional values by the scaling factor.

In another embodiment of the first aspect, the scaling ruler further comprises at least one control input for receiving the measurement input from the user, wherein the measurement input is a value associated with a known dimension.

In another embodiment of the first aspect, the scaling ruler further comprises a readout display, wherein the readout display displays a value based on a position of the pointer relative to the scaled units displayed on the ruler display.

In a second aspect, scaling ruler having a first edge and a second edge is provided, the scaling ruler comprising: a pointer configured to receive a pointer input, wherein the pointer input is a distance associated with a known dimension; at least one input control for receiving a measurement input, wherein the measurement input is a numerical value associated with the known dimension; a ruler display configured to display scaled units; and a readout display configured to display a numerical value based on a position of the pointer relative to the scaled units.

In an embodiment of the second aspect, the at least one input control and the readout display are part of a control module.

In another embodiment of the second aspect, the pointer moves along the ruler display between the first edge and the second edge.

In another embodiment of the second aspect, the pointer is attached to the control module.

In another embodiment of the second aspect, the control module moves along the ruler display between the first edge and the second edge.

In another embodiment of the second aspect, the control module and the ruler display are connected by a communication harness.

In another embodiment of the second aspect, the communication harness is attached to a first connection point on the control module and attached to a second connection point on the ruler display.

In another embodiment of the second aspect, the control module includes a spool, and the communication harness recoils and spools upon itself when retracting and uncoils when extending.

In another embodiment of the second aspect, the ruler display is a digital screen.

In another embodiment of the second aspect, the ruler display is a projector that displays the scaled units by projecting light onto a nearby surface.

### BRIEF DESCRIPTION OF THE DRAWINGS

The various embodiments of the present scaling rulers now will be discussed in detail with an emphasis on highlighting the advantageous features. These embodiments depict the novel and non-obvious scaling rulers shown in the accompanying drawings, which are for illustrative purposes only. These drawings include the following figures:

FIG. 1 is a side view of a scaling ruler in accordance with an embodiment of the invention.

FIG. 2A is a side view of a scaling ruler in a scaling configuration in accordance with an embodiment of the invention.

FIG. 2B is a side view of a scaling ruler in a display configuration in accordance with an embodiment of the invention.

FIG. 3 is a side view of scaling ruler with a sliding control module in accordance with an embodiment of the invention.

FIG. 4A is a side view of a projection-based scaling ruler in accordance with an embodiment of the invention.

FIG. 4B is a front view of a projection-based scaling ruler in accordance with an embodiment of the invention.

FIG. 5 is a diagram of a slide component partially extended in accordance with an embodiment of the invention.

FIG. 6A is a diagram of another slide component partially extended in accordance with an embodiment of the invention.

FIG. 6B is a diagram of another slide component fully extended in accordance with an embodiment of the invention.

FIG. 7 is a side view of a scaling caliper in accordance with an embodiment of the invention.

FIG. 8 is a block diagram of a scaling ruler in accordance with an embodiment of the invention.

FIG. 9 is a flow chart of a process for generating and displaying scaled units in accordance with an embodiment of the invention.

FIG. 10 is a flow chart of a process for calculating a scaling factor in accordance with an embodiment of the invention.

FIG. 11 is a flow chart of a process for generating scaled units in accordance with an embodiment of the invention.

FIG. 12A is a diagram illustrating a poly-line measurement tool in accordance with an embodiment of the invention.

FIG. 12B is a diagram illustrating a polygon area tool in accordance with an embodiment of the invention.

FIG. 12C is a diagram illustrating a line measurement tool in accordance with an embodiment of the invention.

### DETAILED DESCRIPTION OF THE DRAWINGS

The various embodiments of the present scaling rulers for generating and displaying scaled units contain several features, no single one of which is solely responsible for their desirable attributes. Without limiting the scope of the present embodiments, their more prominent features will now be discussed below. In particular, the present scaling rulers will be discussed in the context of drawings. However, the use of drawings (physical or digital) are merely exemplary as scaling rulers may be utilized for various environments as appropriate to the requirements of a specific application in accordance with embodiments of the invention. Further, the present scaling rulers may be described as having a physical pointer that slides via a manual mechanism. However, the use of physical pointers that slide is merely exemplary and pointers may be implemented digitally (e.g., as a digital representation on a ruler display) and may slide via a touch sensitive screen (e.g., a ruler display) or via any other type of input including, but not limited to, haptic inputs (e.g., buttons, scrolling bar, etc.) After considering this discussion, and particularly after reading the section entitled “Detailed Description,” one will understand how the features of the present embodiments provide the advantages described here.

The following detailed description describes the present embodiments with reference to the drawings. In the drawings, reference numbers label elements of the present embodiments. These reference numbers are reproduced below in connection with the discussion of the corresponding drawing features. These figures, and their written descriptions, indicate that certain components of the apparatus are formed integrally, and certain other components are formed as separate pieces. Those of ordinary skill in the art will appreciate that components shown and described herein as being formed integrally may in alternative embodiments be formed as separate pieces. Those of ordinary skill in the art will further appreciate that components shown and described herein as being formed as separate pieces may in alternative embodiments be formed integrally. Further, as used herein the term integral describes a single unitary piece.

Turning now to the drawings, scaling rulers for generating and displaying scaled units in accordance with embodiments of the invention are disclosed. In many embodiments, scaling rulers may have various modes of operations. For example, a scaling ruler may be turned on (and/or off) using an input such as, but not limited to, a button. In some embodiments, a user may select a desired unit of measure such as, but not limited to centimeters (cm), millimeters (mm), inches (in), various engineering and/or architectural scale units, and/or a so-called “custom” unit. In various embodiments, scaling rulers may include an up and/or down selection buttons allowing the user to select their desired units. In several embodiments, the various units may be preloaded into the scaling ruler and when any of the preloaded units are selected, the scaling ruler may present a ruler based on the selected unit to the user. In some embodiments, scaling rulers may also allow the user to manually enter a scale ratio.

In many embodiments, scaling rulers may include a ruler display for presenting the units including, but not limited to, scaled units. In some embodiments, the ruler display may be a digital screen. In some embodiments, the ruler display may be a projector. For example, scaling rulers may present the selected ruler as a projection (e.g., an LED projection) onto a nearby surface. In a variety of embodiments, scaling rulers may also include a moveable indicator (may also be referred to as a “pointer”) that may be moved between a first edge and a second edge of the scaling ruler. In some embodiments, the scaling ruler may allow a user to re-calibrate (e.g., by pressing an input control such as, but not limited to, a haptic button). In various embodiments, when the pointer is moved, the scaling ruler may determine the position of the pointer and provide a digital readout via a readout display.

In various embodiments, scaling rulers may generate and display custom scaled units. For example, a user may select the custom unit option and the scaling ruler may be placed into a scaling configuration for receiving one or more inputs from the user (e.g., a pointer input and/or a measurement input). In some embodiments, the scaling ruler may instruct the user to provide input(s). In the scaling configuration, the ruler display may be clear and/or without any units. In some embodiments, the user may move (may also be referred to as “slide”) the pointer such that a specific predetermined measurement (e.g., a known dimension and/or measurement on a drawing) (this may also be referred to as a “pointer input”) is placed between a first edge of the scaling ruler and the pointer. In various embodiments, the user may also enter a known measurement value (e.g., a numerical value associated with the known dimension) (this may also be referred to as a “measurement input”) using one or more input controls (e.g., haptics) of the scaling ruler. Using the pointer input and the measurement input, the scaling ruler may generate and display a custom scaled ruler having scaled units. In some embodiments, the scaled units may be displayed on the ruler display. In addition, when the user moves the pointer, the scaling ruler may provide a digital readout (e.g., via the readout display) in the scaled units. Scaling rulers in accordance with embodiments of the invention are further discussed below.

### Scaling Rulers

Scaling rulers may be configured to generate and display various units including, but not limited to, a custom scaled unit. As further described below, scaling rulers may include various components such as, but not limited to, a pointer, a ruler display, various input controls (e.g., haptics, buttons, touchscreen, etc.), and a readout display. In some embodiments, scaling rulers may utilize a control module to house the input controls, readout display, one or more batteries, and/or functional electronics (e.g., processor(s), memory, etc.). In custom scale mode, scaling rulers may generate and display a ruler with scaled units (may also be referred to as a “scaled ruler”). For example, scaling rulers may receive a pointer input when a user slides a pointer to a specific position. Further, scaling rulers may receive a measurement input via the one or more input control(s). In many embodiments, scaling rulers may assign a numerical value to the pointer input and generate one or more scaling factors based on the measurement input and the pointer data. The scaling factor may be used to generate scaled units which may be displayed the ruler display.

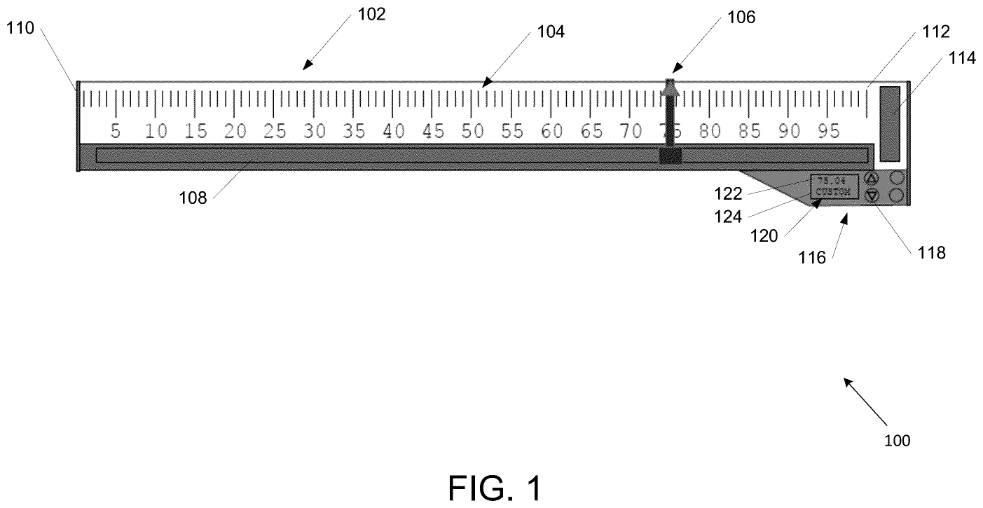

A side view of a scaling ruler in accordance with an embodiment of the invention is shown in FIG. 1. The scaling ruler 100 may include a ruler display 102 for displaying units 104 depending on the user selected mode of operation. In some embodiments, the ruler display 102 may be a clear or translucent surface with an embedded digital screen. In some embodiments, the ruler display 102 may be a digital screen. The scaling ruler 100 may also include a pointer 106 that may slide up and down the ruler 100. In some embodiments, the pointer 106 may be attached to a base 108 that runs parallel to the ruler display 102. In some embodiments, the pointer 106 may be attached directly to the ruler display 102, as further described below. In some embodiments, the pointer 106 may be a digital representation that may be displayed on the ruler display 102. In some embodiments, the pointer 106 may be a digitally displayed pointer and be moved by a touch screen or one or more control inputs.

In reference to FIG. 1, the scaling ruler 100 (or the ruler display 102) may include a first edge 110 and a second edge 112. In some embodiments, the first edge 110 may indicate a lowest value (e.g., a zero value) for any set of units presented on the ruler display 102. Further, the second edge 112 may indicate the highest value (e.g., 100) for any set of units presented on the ruler display 102. In various embodiments, the pointer 106 may slide up and down the scaling ruler 100 between the first edge 110 and the second edge 112 thereby allowing a user to place the pointer 106 on any position along the ruler display 102. In various embodiments, the first edge 110 may be a ruler point that equates to a measurement=0. In many embodiments, the scaling ruler 100 may be able to measure a linear positional value of the pointer 106 in respect to the first edge 110.

In reference to FIG. 1, the user may re-calibrate the scaling ruler 100 by placing the pointer 106 at the first edge 110 and entering an input (e.g., entering 0) to calibrate/recalibrate the scaling ruler 100. In many embodiments, the recalibration may ensure the highest degree of accuracy. In some embodiments, the scaling ruler 100 may also include a solar panel 114 that may be used to power the scaling ruler 100 and/or to charge/recharge one or more batteries used to power the scaling ruler 100.

In further reference to FIG. 1, the scaling ruler 100 may include a control module 116 having one or more control inputs 118 allowing a user to interface with the scaling ruler 100. For example, the one or more control inputs 118 may include, but is not limited to, haptics, input button(s), touch screen, etc. In many embodiments, the one or more control inputs 118 may allow the user controls such as, but not limited to, to power on, power off, select, calibrate/recalibrate, toggle, transition up, transition down, etc. In some embodiments, the one or more control inputs 118 may be a voice active control system implemented in a manner known to one of ordinary skill in the art. In addition, the control module 116 may include a readout display 120 that may provide information such as, but not limited to, a digital measurement readout (e.g., 75.04) 122 based on the position of the pointer 106 relative to the units selected and/or displayed on the ruler display 102. In some embodiments, the control module 116 may also include functional electronics such as, but not limited to, a processor, volatile and/or non-volatile memories, Bluetooth module, microphone, speaker, etc. In some embodiments, the control module 116 may also include a battery compartment that may store one or more batteries to provide power to the scaling ruler 100.

Although a specific scaling ruler is discussed above with respect to FIG. 1, any of a variety of scaling rulers including a variety of components and features as appropriate to the requirements of a specific application can be utilized in accordance with embodiments of the invention. For example, various components are described above as being part of the control module 116. However, the various mentioned components may be separately housed and/or be part of the scaling ruler 100 without being limited to being housed in a control module 116. Scaling rulers utilizing custom scaled units in accordance with embodiments of the invention are further described below.

Scaling Rulers with Custom Units

As described above, scaling rulers may include a custom unit mode that may be selected by a user. In such embodiments, scaling rulers may be configured (may be referred to as a “scaling configuration”) to allow the user to provide measurements such as, but not limited to, pointer inputs and measurement inputs that may be used to generate scaled units, as further described below. In addition, scaling rulers may be configured (may be referred to as a “display configuration”) to provide scaled units to the user thereby providing the user with a custom scaled ruler.

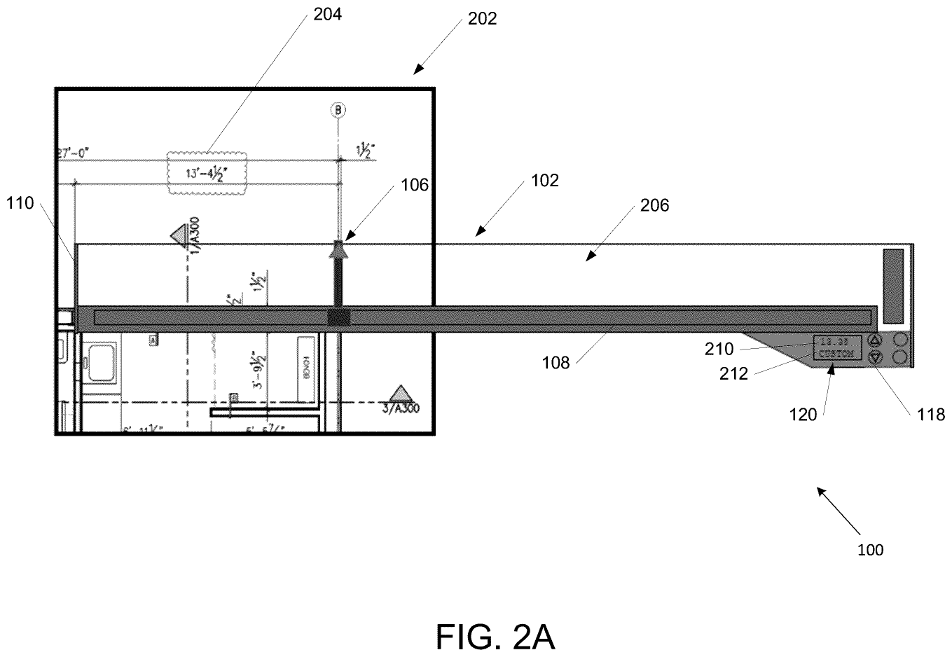

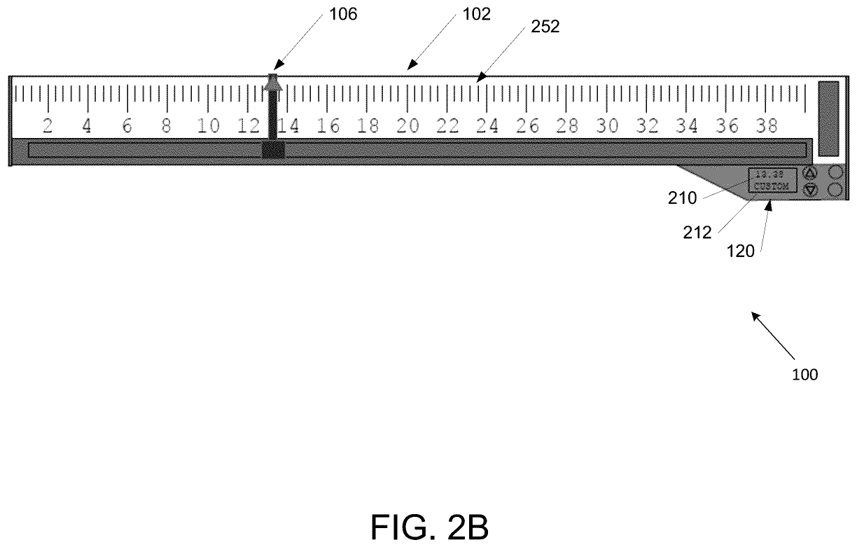

A side view of a scaling ruler in a scaling configuration in accordance with an embodiment of the invention is shown in FIG. 2A. In many embodiments, a user may have a drawing and/or physical object with some known dimension. In reference to FIG. 2A, the user may have an existing drawing 202 with a known dimension 204 having a numerical value of 13′-4.5″. In the scaling configuration, the ruler display 102 may be clear 206 (i.e., no units displayed) when the custom unit is selected. In some embodiments, the ruler display 102 may include a digital readout of instructions to the user for operation in the scaling configuration.

In reference to FIG. 2A, using the existing drawing 202, the user may provide pointer input by aligning the first edge 110 of the scaling ruler 100 with one edge associated with the known dimension 204 and sliding the pointer 106 to the other edge associated with the known dimension 204. By sliding the pointer 106 to a particular position, the scaling ruler 100 may assign a numerical value to the pointer position, as further described below. In addition, the user may provide measurement input by inputting the known dimension 204 (e.g., numerical value 13.38 corresponding to 13′-4.5″ rounded to two decimal places) via the one or more controls 118. In some embodiments, the readout display 120 may display a digital readout 210 of the pointer 106 position relative to the scaled units (i.e., 13.38) and the selected unit 212 (i.e., custom).

A side view of a scaling ruler in a display configuration in accordance with an embodiment of the invention is shown in FIG. 2B. As further described below, the scaling ruler 100 may generate custom scaled units using the pointer input and the measurement input from the user. In many embodiments, the scaling ruler 100 may display the custom scaled units 252 using the ruler display 102 (may be referred to as the “scaled ruler”). The user may now use the scaled ruler to find dimensions on any item or space on the drawing 202.

Although specific drawings, user inputs, and scaling rulers are discussed above with respect to FIGS. 2A-2B, any of a variety of drawings, user inputs, and scaling rulers as appropriate to the requirements of a specific application may be utilized in accordance with embodiments of the invention. For example, users may utilize drawing scales as the known dimensions for providing pointer inputs and measurement inputs in accordance with embodiments of the invention. Design considerations of scaling rulers in accordance with embodiments of the invention are further described below.

### Design Considerations

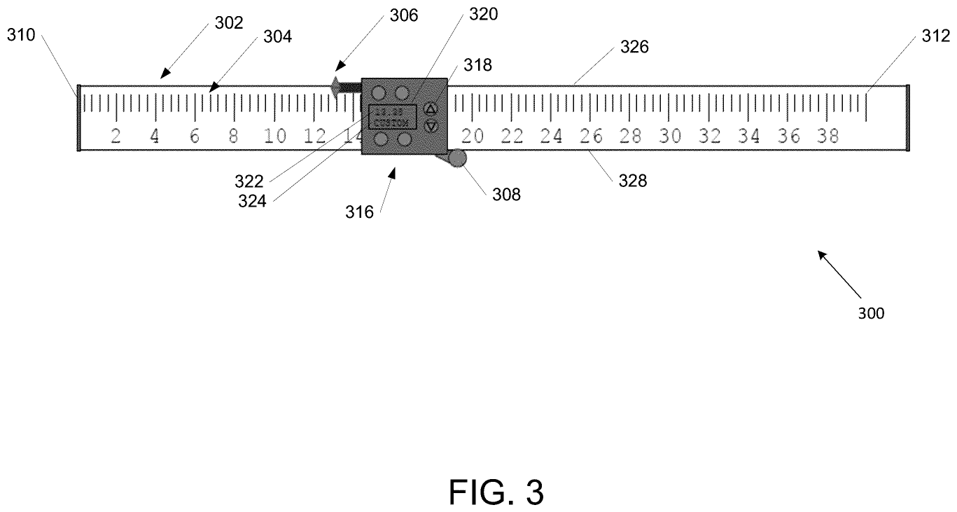

Scaling rulers may be implemented in a variety of manners. A side view of a scaling ruler with a sliding control module in accordance with an embodiment of the invention is shown in FIG. 3. The scaling ruler 300 may include a ruler display 302 that may display units 304, as described above. Moreover, the scaling ruler 300 and/or the ruler display 302 may include a first edge 310 that may be equivalent to a lowest value (e.g., a zero value) and a second edge 312 that may be equivalent to the highest value (e.g., 40) for any set of units presented on the ruler display 302. The scaling ruler 300 may also include a pointer 306 that may be attached to or may be a part of a control module 316. In many embodiments, a user may slide the pointer 306 by sliding the control module 316 along the ruler display 302 via a roller 308. For example, the roller 308 may slide along a bottom edge 328 of the ruler display 302 thereby allowing the control module 316 (and the pointer 306) to slide along the ruler display 302. In some embodiments, the ruler display 302 may include a top edge 326 that may connect to a corresponding portion on the control module 316 to allow the control module 316 to slide along the ruler display 302.

In reference to FIG. 3, the control module 316 may include a readout display 320 (e.g., 13.38) that may provide a digital readout 322 of the pointer 306 position along the ruler display 302, as described above. Moreover, the readout display 320 may provide the units 324 (e.g., custom) that the user has selected, as described above. In addition, the control module 316 may include one or more input controls 318, as described above.

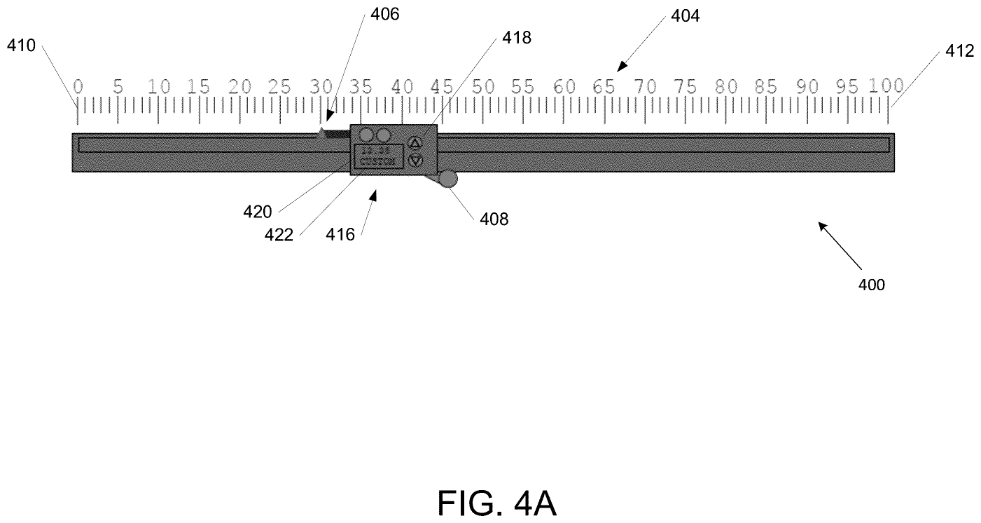

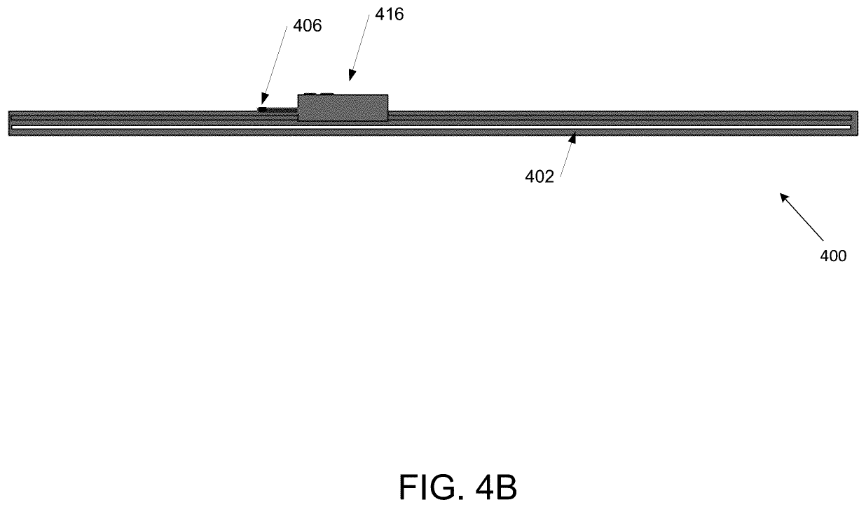

A side view of a projection-based scaling ruler in accordance with an embodiment of the invention is shown in FIG. 4A. The scaling ruler 400 may include a pointer 406 and a control module 416, as described above. Further, the scaling ruler 400 may include a ruler display that is a projector 402 that projects units 404 onto a nearby surface thereby providing a projected scaled ruler. In many embodiments, the projection may include a first edge 410 and a second edge 412, as described above. In many embodiments, the projector 402 may be a light projector.

A front view of a projection-based scaling ruler in accordance with an embodiment of the invention is shown in FIG. 4B. The front view shows the scaling ruler 400 including the pointer 406 and the control module 416. In many embodiments, the projector 402 may be a light projector that projects visible light on to a surface. For example, the projector 402 may include a digital screen that blocks a portion of light from leaving the projector 402 thereby allowing unblocked light to project through to create the projected units 404 as illustrated in FIG. 4A. In some embodiments, the projected units 404 may be controlled (e.g., via distortion) such that when projected out at an appropriate angle on a flat surface directly ahead of the scaling ruler 400, the projected units 404 appear true to scale and font.

Although specific alternative embodiments of scaling rulers are discussed above with respect to FIGS. 3-4B, any of a variety of scaling rulers as appropriate to the requirements of a specific application can be utilized in accordance with embodiments of the invention. Sliding considerations in accordance with embodiments of the invention are further described below.

### Sliding Considerations

As described above, scaling rulers may include a sliding component (e.g., a pointer and/or a control module) that may slide along a fixed component (e.g., a base and/or a ruler display). For example, in some embodiments, a pointer may slide along a base of the scaling ruler thereby allowing the pointer to indicate a position between a first edge and a second edge. In some embodiments, a pointer may be attached to or be part of a control module that may slide along a ruler display thereby allowing the pointer to indicate a position between a first and second edges. In many embodiments, the sliding functionality may allow users to provide pointer inputs. In some embodiments, the fixed and sliding components may be in direct communication via a communication harness (e.g., an electrical wire, optical fiber, etc.) to provide various functionalities of scaling rulers, as described herein. In some embodiments, the fixed and sliding components may be in wireless communication via a wireless protocol such as, but not limited to, Bluetooth, etc.

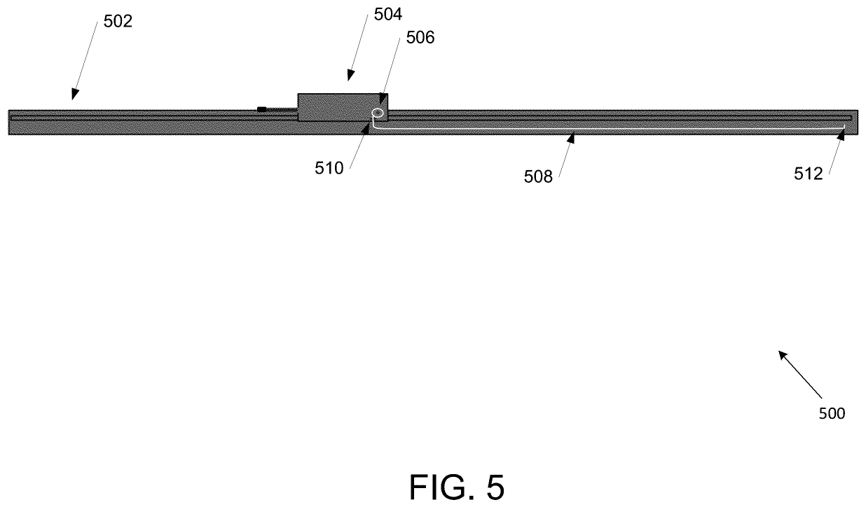

A diagram of a slide component partially extended in accordance with an embodiment of the invention is shown in FIG. 5. The scaling ruler 500 may include a fixed component 502 and a sliding component 504. Illustrating inside components, the sliding component 504 may include a spool 506 on which a communication harness 508 may be wound. The communication harness 508 may be attached to the sliding component 504 at a first connection point 510 and attached to the fixed component 502 at a second connection point 512 (e.g., at or near a first edge or second edge). When the sliding component 504 slides away from the second connection point 512, the communication harness 508 may unwind from the spool 506 and extend. When the sliding component 504 slides towards the second connection point 512, the communication harness 508 may wind in the spool 506 and retract. In other words, the communication harness 508 may recoil and spool upon itself when retracting and uncoil when extending. In many embodiments, the communication harness 508 may be thin, flat, and durable.

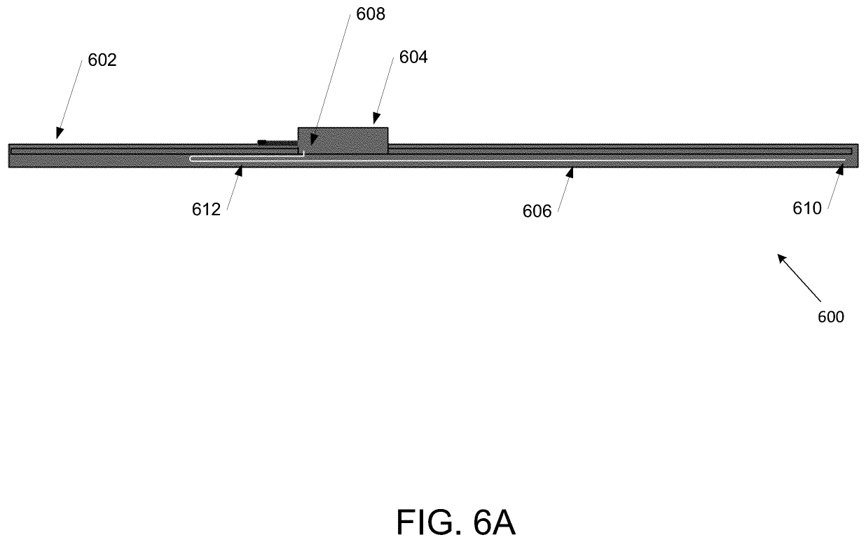

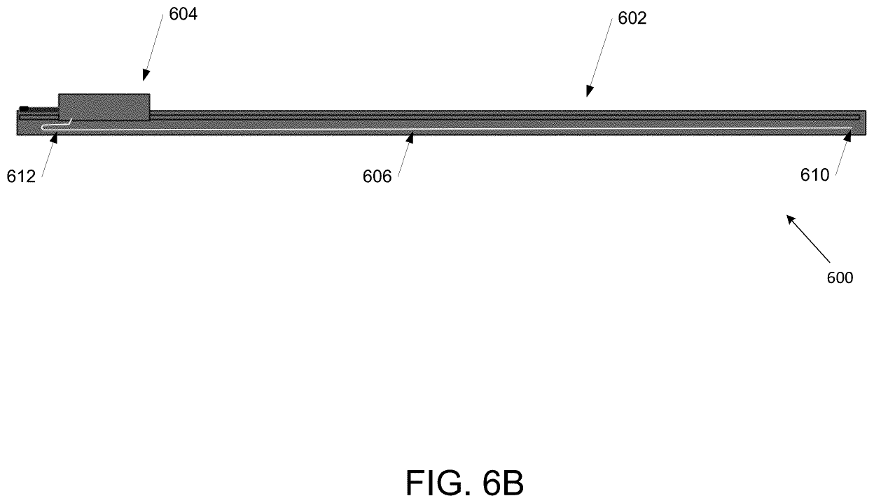

A diagram of another slide component partially extended in accordance with an embodiment of the invention. The scaling ruler 600 may include a fixed component 602 and a sliding component 604. A communication harness 606 may be attached to the sliding component 604 at a first connection point 608 and attached to the fixed component 602 at a second connection point 610 (e.g., at or near a first edge or second edge). When the sliding component 604 is partially extended, a portion of the communication harness 606 may fold over itself 612. The closer that the sliding component 604 slides towards the second connection point 610, the longer the portion of the communication harness 606 may fold over itself 612. A diagram of another slide component fully extended in accordance with an embodiment of the invention is shown in FIG. 6B. When the slide component 602 fully extends by sliding away from the second connection point 610 of the fixed component 602, the communication harness 606 may also extend and the portion of the communication harness 606 that folds on itself 612 may shorten.

Although specific sliding considerations for scaling rulers are discussed above with respect to FIGS. 5-6B, any of a variety of sliding considerations for scaling rulers as appropriate to the requirements of a specific application can be utilized in accordance with embodiments of the invention. Calipers with scaling rulers in accordance with embodiments of the invention are further described below.

Calipers with Scaling Ruler

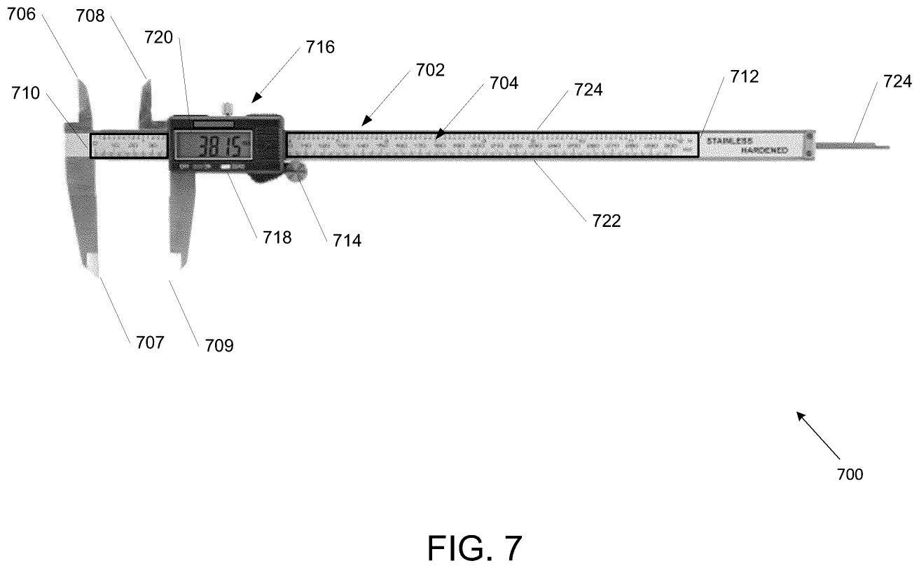

Scaling rulers may be implemented in a variety of measuring devices such as, but not limited to, calipers (may be referred to as “scaling calipers”). In various embodiments, scaling calipers may be used to obtain dimension for real objects that have been reproduced at some scale and may not be the original dimensions. A side view of a scaling caliper in accordance with an embodiment of the invention is shown in FIG. 7. The scaling caliper 700 may include a ruler display 702 that may display units 704, as described above. For example, the ruler display 702 may be a clear or translucent surface with an embedded digital screen. In some embodiments, the ruler display 702 may be a digital screen. In some embodiments, in the scaling configuration, the ruler display 702 may be clear (i.e., no units displayed) when the custom unit is selected. In some embodiments, the ruler display 702 may include a digital readout of instructions to the user for operation in the scaling configuration.

In reference to FIG. 7, the ruler display 702 may include a first edge 710 that may be equivalent to a lowest value (e.g., a zero value) and a second edge 712 that may be equivalent to the highest value for any set of units presented on the ruler display 702. The scaling caliper 700 may include a set of outward facings tips and inward facing tips. For example, the scaling caliper 700 may include a first outward facing tip 706 and a second outward facing tip 708 (may also be referred to as the “outward facing pointer”). Further, the scaling caliper 700 may include a first inward facing tip 707 and a second inward facing tip 709 (may also be referred to as the “inward facing pointer”). In some embodiments, the outward facing pointer 708 and the inward facing pointer 709 that may be attached to or may be a part of a control module 716. A user may utilize either the outward facing tips 706, 708 or the inward facing tips 707, 709 depending on the item (or drawing) that the user is measuring. In many embodiments, the first outward facing tip 706 and the first outward facing tip 707 have be fixed and the outward facing pointer 708 and the inward facing pointer 709 may slide along the ruler display 702 for receiving a user's pointer input, as described above.

In reference to FIG. 7, a user may slide either the outward and/or the inward facing pointers 708, 709 by sliding the control module 716 along the ruler display 702 via a roller 714. For example, the roller 714 may slide along a bottom edge 724 of the ruler display 702 thereby allowing the control module 716 (and the outward and inward pointers 798, 709) to slide along the ruler display 702. In some embodiments, the ruler display 702 may include a top edge 724 that may connect to a corresponding portion on the control module 716 to allow the control module 716 to slide along the ruler display 702.

In further reference to FIG. 7, the control module 716 may include a readout display 720 that may provide a digital readout of either of the outward or inward pointers 708, 709 position along the ruler display 702, as described above. Moreover, the readout display 720 may provide the units that the user has selected, as described above. In addition, the control module 716 may include one or more input controls 718 for receiving a user's measurement input, as described above.

In further reference to FIG. 7, the scaling caliper 700 may also include a depth rod 724 for measuring insertion depth. The depth rod 724 may extend out from the scaling caliper 700 caliper to measure a depth of a particular object by putting the depth rod 724 into an opening (e.g., a hole) that a user is getting a measurement of. For example, a user can have the depth rod 724 extend more or less further from the scaling caliper 700 by adjusting the depth rod 724 so that it hits the bottom of the hole and pressing against the interior wall of the hole. In many embodiments, the measured insertion depth may be used as the pointer input and along with a user's measurement input may be used to generate a scaling ruler as described herein.

Although specific scaling calipers are discussed above with respect to FIG. 7, any of a variety of scaling calipers as appropriate to the requirements of a specific application can be utilized in accordance with embodiments of the invention. Generating scaling rulers in accordance with embodiments of the invention are further described below.

### Generating Scaled Units

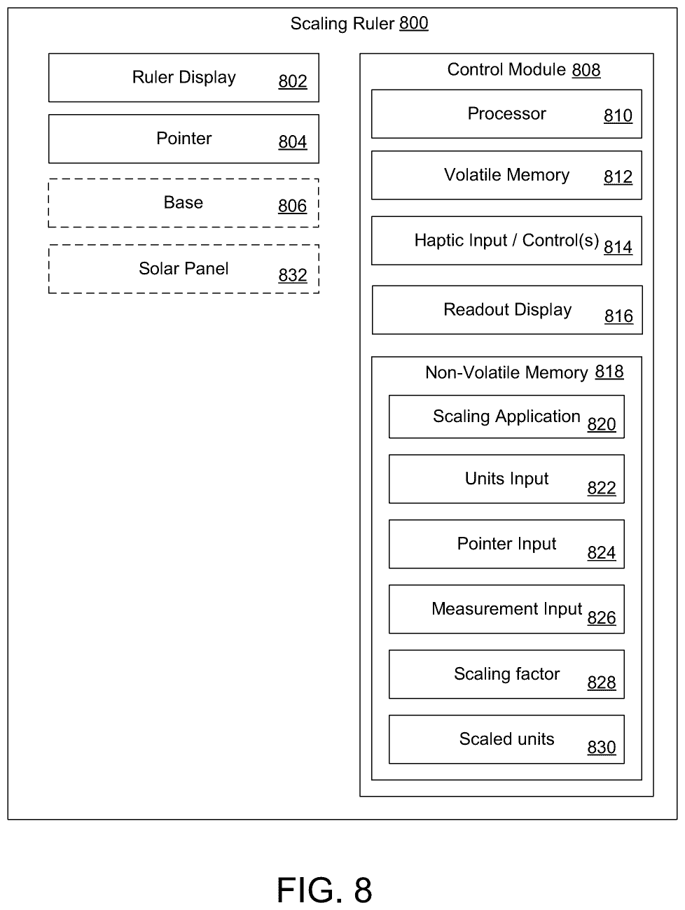

Scaling rulers may generate scaled units using pointer input and measurement input and display the scaled units on to a ruler display, as described above. A block diagram of a scaling ruler in accordance with an embodiment of the invention is shown in FIG. 8. The scaling ruler 800 may include a control module 808 that is operatively connected to a ruler display 802 and a pointer 804. In some embodiments, the control module 808 may also be operatively connected to a base 806 and/or a solar panel 832. The control module 808 may include a processor 810, a volatile memory 812, and non-volatile memory 818 that may include a scaling application 820. In some embodiments, the control module 808 may also include one or more haptic input/controls 814 for receiving user input, as described above. In many embodiments, the scaling application 820 may configure the processor 810 to receive data from a user including, but not limited to, a selection of units (may also be referred to as “units input” 822), a pointer input 824, and a measurement input 826. For example, the user may provide units input 822 using the haptic input/control(s) 814, as described above. Further, the user may provide pointer input 824 using the pointer 804, as described above. In addition, the user may provide measurement input 826 using the haptic input/control(s) 814, as described above. In some embodiments, the user may also provide a power on or a power off input that either turns on or turns off, respectively, the scaling ruler 800.

In reference to FIG. 8, the scaling application 820 may configure the processor 810 to calculate a scaling factor 828 based on the pointer input 824 and the measurement input 826, as further described below. In addition, the scaling application 820 may configure the processor 810 to generate scaled units 830 using the scaling factor 828 and display the scaled units 830 on the ruler display 802, as further described below.

In the illustrated embodiment of FIG. 8, the various components including, but not limited to, the ruler display 802, pointer 804, and the control module 808 are represented by separate boxes. The graphical representations depicted in FIG. 8 are, however, merely examples, and are not intended to indicate that any of the various components of the scaling ruler 800 are necessarily physically separate from one another, although in some embodiments they might be. In other embodiments, however, the structure and/or functionality of any or all of the components of scaling ruler 800 may be combined. In addition, in some embodiments, the ruler display 802 may include its own processor, volatile memory, and/or non-volatile memory.

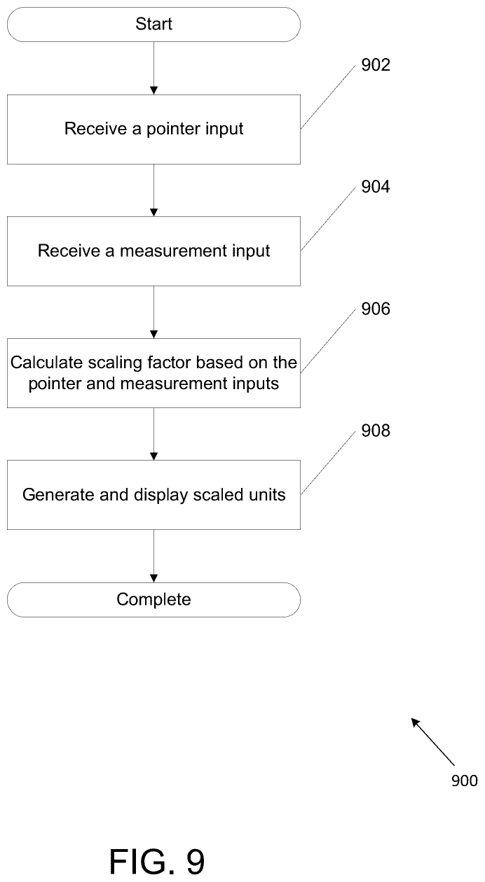

A flow chart of a process for generating and displaying a scaled ruler in accordance with an embodiment of the invention is shown in FIG. 9. The process 900 may include receiving (902) a pointer input from a user. For example, a user may provide a pointer input by moving a pointer along a scaling ruler to position indicating a known dimension, as described above. The process 900 may also include receiving (904) a measurement input from the user. For example, a user may provide a numerical value of the known dimension corresponding to the pointer input, as described above. Further, the process 900 may include calculating (906) a scaling factor based on the pointer input and the measurement input, as further described below. The process 900 may also include generating (908) and displaying (908) scaled units, as further described below.

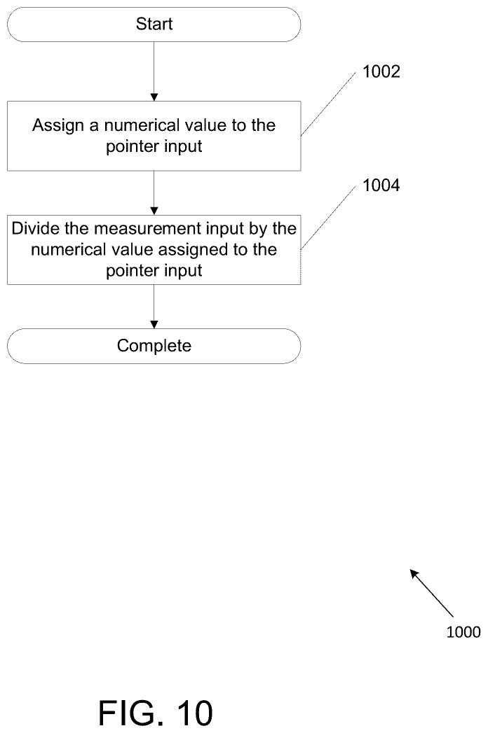

A flow chart of a process for calculating (906) a scaling factor in accordance with an embodiment of the invention is shown in FIG. 10. The process 1000 may include assigning (1002) a numerical value to the pointer input. For example, the numerical value may be assigned based on the position that the user has moved the pointer relative to a first edge and/or a second edge of a scaling ruler. In this way, the scaling ruler may be able to numerically represent any position along the ruler display relative to any other position on the ruler display. In some embodiments, each position along the ruler display from a first edge to a second edge may have a position value. Thus, the pointer input value may be the position value corresponding to the position of the pointer along the ruler display. The process 1000 may further include dividing (1004) the measurement input by the assigned numerical value of the pointer input and thus generating a scaling factor. In some embodiments, the scaling factor may be used to convert between various units, including but not limited to, custom scaled units, as further described below.

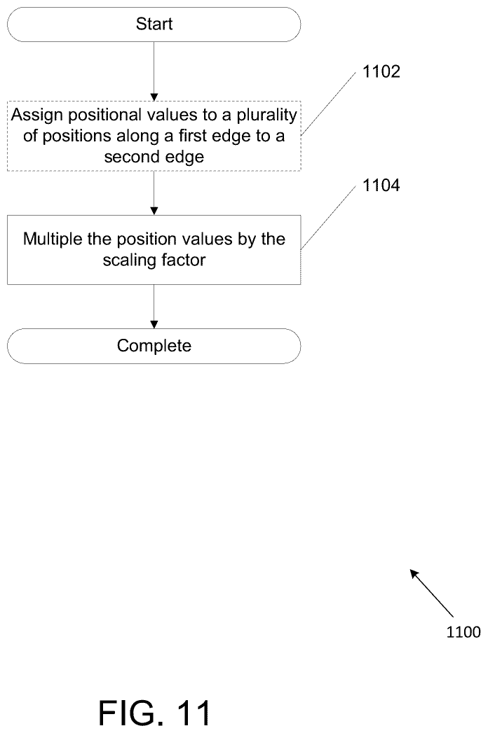

A flow chart of a process for generating (908) and displaying (908) scaled units in accordance with an embodiment of the invention is shown in FIG. 11. The process 1100 may include assigning (1102) positional values, such as, but not limited to, numerical values to a plurality of positions along the ruler display from a first edge to a second edge. For example, the position values may increase sequentially from the first edge to the second edge. In some embodiments, the position values may be predetermined and thus step (1102) may be optional. The process 1100 may further include multiplying (1104) the position values by the scaling factor thereby generating scaled units. For example, consider a slope intercept equation y=mx+b for a straight line applied to scaling rulers. Since a scaling ruler will measure 0 at position 0, b=0, then the equation becomes y=mx. The variable x may be taken by the scaling ruler as a known position or distance of the pointer in respect to ruler position=0. The variable y may be a known scaled dimension associated with the pointer position and input by the user. The value m may be calculated by m=y/x. Once the scale (m) is calculated, the scaling ruler may generate a ruler display using this customized linear scale. One of ordinary skill will appreciate that a linear scale may be derived using various other methods, but this may be the simplest. In many embodiments, the scaled units may be displayed (908) on the ruler display thereby providing a custom scaled ruler to the user.

Although specific scaling rulers and processes are discussed above with respect to FIGS. 8-11, any of a variety of scaling rulers and process as appropriate to the requirements of a specific application can be utilized in accordance with embodiments of the invention. Digital scaling rulers in accordance with embodiments of the invention are further described below.

### Digital Scaling Rulers

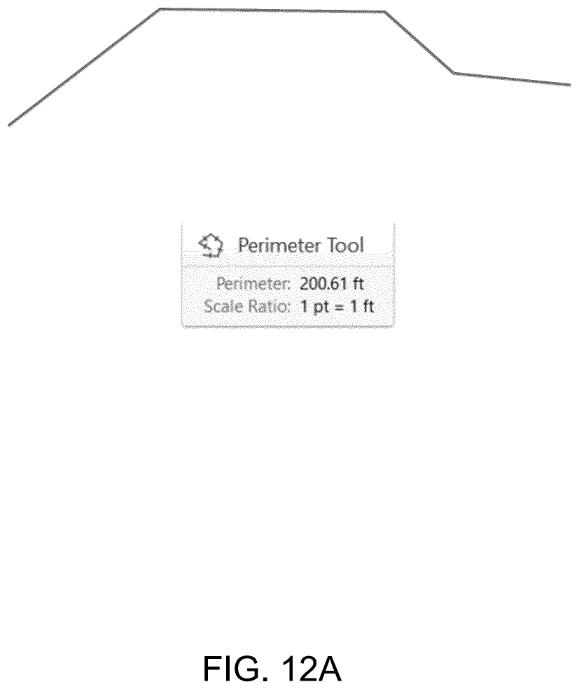

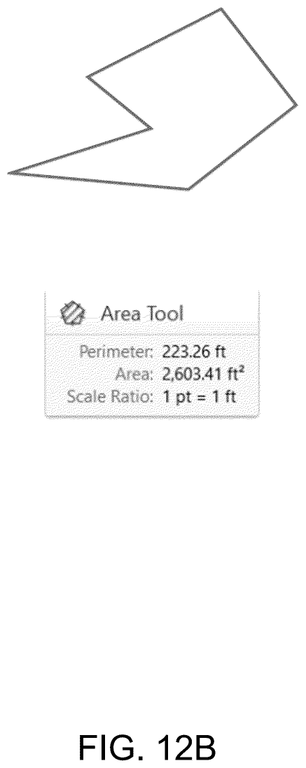

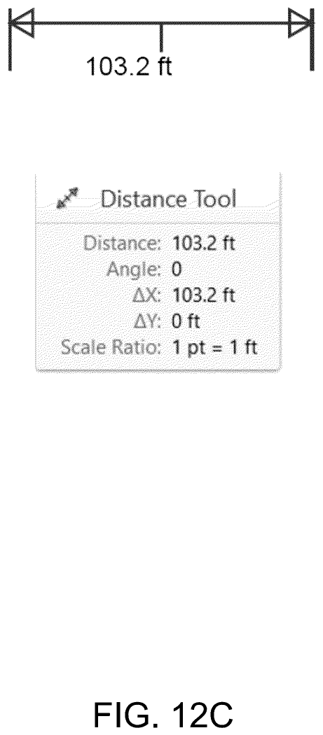

Scaling rulers may be implemented in digital formats. For example, software may be utilized to create completely digital tools (e.g., scaling rulers, scaling calipers, etc.) that could be used to measure screen items on a computer screen, such as, but not limited to, drawings, pdf documents, maps, etc. For example, a menu could provide various types of tools such as, but not limited to, a digital caliper, translucent ruler, and other tools such as poly-line path measurement widget, polygon area widget, and line measurement widget. Using a user's measurement input and virtual pointer input, scaling functions may be performed and further, functions may be performed for area, volume, and pi-based measurement widgets such as perimeter, area, or a circle, etc. A diagram illustrating a poly-line measurement tool in accordance with an embodiment of the invention is shown in FIG. 12A. A diagram illustrating a polygon area tool in accordance with an embodiment of the invention is shown in FIG. 12B. A diagram illustrating a line measurement tool in accordance with an embodiment of the invention is shown in FIG. 12C.

Although specific digital tools using scaling rulers are discussed above with respect to FIGS. 12A-12C, any of a variety of digital tools using scaling rulers as appropriate to the requirements of a specific application can be utilized in accordance with embodiments of the invention. While the above description contains many specific embodiments of the invention, these should not be construed as limitations on the scope of the invention, but rather as an example of one embodiment thereof. It is therefore to be understood that the present invention may be practiced otherwise than specifically described, without departing from the scope and spirit of the present invention. Thus, embodiments of the present invention should be considered in all respects as illustrative and not restrictive.

What is claimed is:

1. A scaling ruler, comprising:
a pointer configured to move along the scaling ruler;
a ruler display configured to display scaled units;
a control module comprising a processor operatively connected to the pointer and the ruler display; and
memory storing a program comprising instructions that, when executed by the processor, cause the scaling ruler to:
receive a pointer input from a user;
receive a measurement input from the user;
calculate a scaling factor based on the pointer input and the measurement input; and
generate scaled units based on the scaling factor and display the scaled units on the ruler display.

2. The scaling ruler of claim 1 further comprising a base, wherein the pointer moves along the scaling ruler via the base.

3. The scaling ruler of claim 1, wherein the scaling ruler includes a first edge and a second edge.

4. The scaling ruler of claim 3, wherein the scaling ruler receives the pointer input from the user when the user moves the pointer into a position indicating a known dimension.

5. The scaling ruler of claim 4, wherein the pointer input is a distance between the first edge and the position of the pointer.

6. The scaling ruler of claim 1, wherein the scaling factor is calculated by assigning a value to the pointer input and dividing the measurement input by the value assigned to the pointer input.

7. The scaling ruler of claim 3, wherein a space between the first edge and the second edge is assigned positional values.

8. The scaling ruler of claim 7, wherein the scaled units are generated by multiplying the positional values by the scaling factor.

9. The scaling ruler of claim 1 further comprising at least one control input for receiving the measurement input from the user, wherein the measurement input is a value associated with a known dimension.

10. The scaling ruler of claim 1 further comprising a readout display, wherein the readout display displays a value based on a position of the pointer relative to the scaled units displayed on the ruler display.

11. A scaling ruler having a first edge and a second edge, the scaling ruler comprising:
a pointer configured to receive a pointer input, wherein the pointer input is a distance associated with a known dimension;
at least one input control for receiving a measurement input, wherein the measurement input is a numerical value associated with the known dimension;
a ruler display configured to display scaled units; and
a readout display configured to display a numerical value based on a position of the pointer relative to the scaled units.

12. The scaling ruler of claim 11, wherein the at least one input control and the readout display are part of a control module.

13. The scaling ruler of claim 11, wherein the pointer moves along the ruler display between the first edge and the second edge.

14. The scaling ruler of claim 12, wherein the pointer is attached to the control module.

15. The scaling ruler of claim 11, wherein the control module moves along the ruler display between the first edge and the second edge.

16. The scaling ruler of claim 11, wherein the control module and the ruler display are connected by a communication harness.

17. The scaling ruler of claim 16, wherein the communication harness is attached to a first connection point on the control module and attached to a second connection point on the ruler display.

18. The scaling ruler of claim 17, wherein the control module includes a spool, and the communication harness recoils and spools upon itself when retracting and uncoils when extending.

19. The scaling ruler of claim 11, wherein the ruler display is a digital screen.

20. The scaling ruler of claim 11, wherein the ruler display is a projector that displays the scaled units by projecting light onto a nearby surface.
